(19) United States
(12) Patent Application Publication
(10) Pub. No.: US 2026/0176467 A1
(43) Pub. Date: Jun. 25, 2026

(54) PEBA FOR DIRECT ADHESION TO TPU COMPRISING HOLLOW GLASS BEADS

(71) Applicant: ARKEMA FRANCE, COLOMBES (FR)

(72) Inventors: Romain DAVID, SHIMOGYO-KU, Kyoto (JP); Guillaume VINCENT, CHANGSHU, Jiangsu (CN); Clémence PACE, SHIMOGYO-KU, Kyoto (JP)

(73) Assignee: ARKEMA FRANCE, COLOMBES (FR)

(21) Appl. No.: 18/821,314

(22) PCT Filed: Feb. 24, 2023
(86) PCT No.: PCT/FR2023/050261

§ 371 Date: Aug. 30, 2024

(30) Foreign Application Priority Data
Mar. 2, 2022 (FR) FR2201810

(51) Int. Cl. C08L 77/00; B29C 48/08; B32B 27/32; C08G 18/32; C08G 18/40; C08G 18/76; C08L 77/06

(52) U.S. Cl. CPC C08L 77/00; B29C 48/08; B32B 27/32; C08G 18/3206; C08G 18/4018; C08G 18/7664; C08L 77/06; C08L 2205/02; C08L 2205/025

(57) ABSTRACT

The present invention relates to an article comprising a first polymer material comprising at least one copolymer comprising PA polyamide blocks and PE polyether blocks (PEBA) and a second polymer material comprising at least one thermoplastic polyurethane (TPU), the first polymer material adhering directly to the second adhering polymer material, and the second polymer material comprising hollow glass beads. The present invention also relates to the assembly of the first polymer material onto the second polymer material comprising hollow glass beads by a direct adhesion process.

### FIELD OF THE INVENTION

The present invention relates to an article comprising a first polymer material comprising at least one copolymer comprising PA polyamide blocks and PE polyether blocks (PEBA) and a second polymer material comprising at least one thermoplastic polyurethane (TPU), the first polymer material adhering directly to the second polymer material, and the second polymer material comprising hollow glass beads. The present invention also relates to the assembly of the first polymer material onto the second polymer material comprising hollow glass beads by a direct adhesion process.

### TECHNICAL BACKGROUND

Materials based on thermoplastic elastomer (TPE) polymers, such as PEBA or TPU copolymers, or copolyether block esters (CoPE), are known for their use in the manufacture of automotive parts, sports equipment, in particular sports shoes, electrical and electronic equipment parts, medical equipment parts, etc.

The assembly of these materials of similar or different chemical natures and mechanical properties is sometimes required for these applications. The assembly may be carried out by molding or extrusion, optionally cutting the components, then gluing and pressing these components, or else by a process of direct adhesion of these TPEs.

The term “direct adhesion process” is understood to mean an adhesion process without the addition of binder, in particular without the addition of glue or adhesive, the glue or adhesive possibly proving to be polluting and therefore more difficult to recycle. Compared with conventional adhesive bonding processes involving a multitude of complex steps generally using adhesives based on organic solvents, direct adhesion processes are more economical and non-polluting. As an example of a direct adhesion process, mention may be made of: overmolding, hot pressing, co-extrusion, thermoforming, co-injection, and any other possible adhesion method using one or more of the conventional methods such as injection molding, extrusion molding, and/or blow molding.

More particularly, the overmolding technique consists in injecting material onto an insert placed at the bottom of the mold. The adhesion of the two materials is obtained through the properties of adhesion in the molten state and of compatibility of the overmolded material and of the insert.

Unfortunately, the level of adhesion of TPE-based materials, of systems obtained by direct adhesion, is not always optimal.

Furthermore, these TPE-based materials may comprise additives and reinforcements, such as fibers or glass beads, for electronic, sports, automotive or industrial applications in order to improve the mechanical properties. Furthermore, the addition of hollow glass beads has been envisioned in the past, making it possible to provide the final article with lightness in order to consume less energy or to reduce as much as possible the energy expended during use thereof.

However, these additives and/or reinforcements may have harmful impacts, such as adhesion problems during assembly thereof. For example, in “Investigation of the interfacial adhesion of glass bead-filled multicomponent injection molded composites, Suplicz et al., IOP Conf. Series: Materials Science and Engineering 903 (2020)”, a decrease in the adhesion strength between 2 overmolded materials comprising glass fibers or glass beads was observed due to poor adhesion.

There is therefore a real need to provide articles with good adhesion between these various materials comprising additives and/or reinforcements, in particular comprising hollow glass beads.

### SUMMARY OF THE INVENTION

The invention relates firstly to an article comprising a first polymer material comprising at least one copolymer comprising polyamide blocks and polyether blocks (PEBA) and a second polymer material comprising at least one thermoplastic polyurethane (TPU), the first polymer material adhering directly to the second polymer material, and the second polymer material comprising hollow glass beads.

According to one embodiment, the adhesion between two polymer materials, expressed as the peel strength in kgf/cm, is greater than or equal to 10 kgf/cm, preferably greater than or equal to 12 kgf/cm.

According to one embodiment, the hollow glass beads have a content of 3% to 25% by weight relative to the total weight of the second polymer material.

According to one embodiment, the hollow glass beads comprise zinc oxide having a content greater than or equal to 1.0% by weight relative to the total weight of the hollow glass beads, and preferably greater than or equal to 2.0% by weight relative to the total weight of the hollow glass beads.

The present invention makes it possible to meet the need expressed above: in addition to good direct adhesion between the different TPE materials, it also provides articles having a desired low density.

The present invention also provides a process for direct adhesion of a first polymer material comprising at least one PEBA to a second polymer material comprising at least one TPU and hollow glass beads, the process being characterized in that the assembly is carried out by a process comprising heating the first polymer material, and this material melted or softened under heating is brought into contact with at least a portion of the second polymer material so as to adhere the two materials together.

Surprisingly, it has been discovered that the presence of hollow glass beads makes it possible to provide articles having a reduced density without influencing the adhesion between the first and second polymer materials. More specifically, despite the presence of the hollow glass beads close to the interface of the two polymer materials, the adhesion between these two materials is maintained, or even improved.

For the purposes of the present invention, the expression “maintained adhesion” or “similar adhesion” is understood to mean a ratio between the adhesion of the materials in the presence of the hollow glass beads and the adhesion of the same materials without the hollow glass beads that is greater than 75%.

The invention also relates to the use of an article as defined above for the manufacture of sports equipment, a shoe element, personal protective equipment, automotive parts, construction parts, optical equipment parts, electrical and electronic equipment parts (for example AR/VR headsets, smartphone parts, computer hardware), medical equipment parts such as catheters, or transmission or conveyor belts.

### DETAILED DESCRIPTION

The invention is now described in more detail and in a nonlimiting way in the description which follows.

### Article

Firstly, the invention relates to an article comprising a first polymer material and a second polymer material, wherein the first polymer material adheres directly to the second polymer material. The term “adhere directly” or “direct adhesion” is understood to mean adhesion without the addition of binder, in particular without the addition of glue or adhesive. Preferably, this article is obtained by the direct adhesion process described below.

### First Polymer Material

The first polymer material according to the invention comprises at least one copolymer comprising PA polyamide blocks and PE polyether blocks (PEBA).

PEBA copolymers result from the polycondensation of polyamide blocks having reactive ends with polyether blocks having reactive ends, such as:
1) polyamide blocks bearing diamine chain ends with polyoxyalkylene blocks bearing dicarboxylic chain ends;
2) polyamide blocks bearing dicarboxylic chain ends with polyoxyalkylene blocks bearing diamine chain ends (known as polyetheramine), obtained by cyanoethylation and hydrogenation of α,ω-dihydroxylated aliphatic polyoxyalkylene blocks (known as polyetherdiols);
3) polyamide blocks bearing dicarboxylic chain ends with polyetherdiols, the products obtained being, in this particular case, polyetheresteramides.

The polyamide blocks bearing diamine chain ends originate, for example, from the condensation of polyamide precursors in the presence of a chain-limiting diamine. The polyamide blocks bearing dicarboxylic chain ends originate, for example, from the condensation of polyamide precursors in the presence of a chain-limiting dicarboxylic acid.

Three types of polyamide blocks may advantageously be used.

According to a first type, the polyamide blocks originate from the condensation of a dicarboxylic acid, in particular those having from 4 to 36 carbon atoms, preferably those having from 6 to 18 carbon atoms, and of an aliphatic or aromatic diamine, in particular those having from 2 to 20 carbon atoms, preferably those having from 4 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids. These dimerized fatty acids preferably have a dimer content of at least 98%; they are preferably hydrogenated; they are, for example, products sold under the brand name Pripol by Croda, or under the brand name Empol by BASF, or under the brand name Radiacid by Oleon, and polyoxyalkylene α,ω-diacids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis-(3-methyl-4-aminocyclohexyl)propane (BMACP), and para-aminodicyclohexylmethane (PACM), and isophoronediamine (IPDA), 2,6-bis(aminomethyl)norbornane (BAMN) and piperazine (Pip).

There are, for example, PA 412, PA 414, PA 418, PA 610, PA 612, PA 614, PA 618, PA 912, PA 1010, PA 1012, PA 1014 and PA 1018 blocks. In the PA XY notation, X represents the number of carbon atoms resulting from the diamine residues and Y represents the number of carbon atoms resulting from the diacid residues, in a conventional way.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 36 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are made of PA 11, PA 12 or PA 6.

According to a third type, the polyamide blocks result from the condensation of at least one α,ω-aminocarboxylic acid (or a lactam), at least one diamine and at least one dicarboxylic acid. In the notation PA X, X represents the number of carbon atoms derived from amino acid residues.

In this case, the polyamide PA blocks are prepared by polycondensation:
of the diamine(s) containing X carbon atoms;
of the dicarboxylic acid(s) having Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y);
said comonomer(s) {Z} being introduced in a weight proportion ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid having Y carbon atoms is used as chain limiter, which is introduced in excess relative to the stoichiometry of the diamine(s).

According to one variant of this third type, the polyamide blocks result from the condensation of at least two α,ω-aminocarboxylic acids or of at least two lactams containing from 6 to 12 carbon atoms or of one lactam and of one aminocarboxylic acid not having the same number of carbon atoms, in the optional presence of a chain limiter. α,ω-Aminocarboxylic acids, lactams, diamines and dicarboxylic acids may be of the aforementioned types.

As examples of polyamide blocks of the third type, mention may be made of the following: 66/6, 66/610/11/12.

Preferably, the polymer comprises from 1% to 80% by mass of polyether blocks and from 20% to 99% by mass of polyamide blocks, preferably from 4% to 80% by mass of polyether blocks and from 20% to 96% by mass of polyamide blocks.

The polyether blocks consist of alkylene oxide units. The blocks may notably be derived from PEG (polyethylene glycol) blocks, i.e. those consisting of ethylene oxide units, PPG (propylene glycol) blocks, i.e. those consisting of propylene oxide units, PO3G (polytrimethylene glycol) blocks, i.e. those consisting of polytrimethylene glycol ether units, and/or PTMG (polytetramethylene glycol) blocks, i.e. those consisting of tetramethylene glycol units, also known as polytetrahydrofuran. The PEBA copolymers may comprise in their chain several types of polyethers, the copolyethers possibly being in block or statistical form.

Use may also be made of blocks obtained by oxyethylation of bisphenols, for instance bisphenol A. The latter products are described in patent EP 613919.

The polyether blocks may also consist of ethoxylated primary amines. As examples of ethoxylated primary amines, mention may be made of the products of formula:

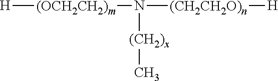

wherein m and n are between 1 and 20, and x is between 8 and 18. These products are commercially available under the Noramox® brand from Arkema and under the Genamin® brand from Clariant.

The polyether blocks may comprise polyoxyalkylene blocks bearing OH diol chain ends (known as polyether diols).

The polyether blocks can comprise polyoxyalkylene blocks having NH₂ diamine chain ends, it being possible for such blocks to be obtained by cyanoacetylation of α,ω-dihydroxylated aliphatic polyoxyalkylene blocks. More particularly, use may be made of the Jeffamine or Elastamine commercial products (for example Jeffamine® D400, D2000, ED 2003, XTJ 542, commercial products from Huntsman).

According to one embodiment, the polyether blocks in the copolymer are polyether diols.

The general method for the two-step preparation of PEBA copolymers having ester bonds between the PA blocks and the PE blocks is known and is described, for example, in the French patent FR 2 846 332. The general method for the preparation of the PEBA copolymers of the invention containing amide bonds between the PA blocks and the PE blocks is known and is described, for example, in European patent EP 1 482 011. The polyether blocks can also be mixed with polyamide precursors and a diacid chain limiter in order to prepare polymers having polyamide blocks and polyether blocks which have randomly distributed units (one-step process).

Needless to say, the name PEBA in the present description of the invention relates not only to the Pebax® products sold by Arkema, to the Vestamid® products sold by Evonik® and to the Grilamid® products sold by EMS, but also to the Kellaflex® products sold by DSM or to any other PEBA from other suppliers.

Advantageously, the PA blocks of the PEBA copolymer may be chosen from PA 6, 11, 12, 612, 66/6, 1010, 614, and/or the copolymer thereof, preferably PA 11, 12 and/or the copolymer thereof; and/or the PE blocks of the PEBA copolymer are PTMG blocks.

Advantageously, said PEBA used in the composition according to the invention is at least partially obtained from biobased raw materials.

The term “raw materials of renewable origin” or “biobased raw materials” is understood to mean materials which comprise biobased carbon or carbon of renewable origin. Specifically, unlike materials resulting from fossil substances, materials composed of renewable starting materials contain ¹⁴C. The “content of carbon of renewable origin” or “content of biobased carbon” is determined by application of the standards ASTM D 6866 (ASTM D 6866-06) and ASTM D 7026 (ASTM D 7026-04). By way of example, the PEBAs based on polyamide 11 at least partly originate from biobased raw materials and have a content of biobased carbon of at least 1%, which corresponds to a ¹²C/¹⁴C isotope ratio of at least 1.2×10⁻¹⁴. Preferably, the PEBAs according to the invention comprise at least 50% by mass of biobased carbon relative to the total mass of carbon, which corresponds to a ¹²C/¹⁴C isotope ratio of at least 0.6×10⁻¹². This content is advantageously higher, notably up to 100%, which corresponds to a ¹²C/¹⁴C isotope ratio of 1.2×10⁻¹², in the case, for example, of PEBA containing PA 11 blocks and PE blocks comprising PO3G, PTMG and/or PPG derived from starting materials of renewable origin.

The first polymer material may comprise a PEBA content of from 70% to 97%, and preferably from 80% to 96% by weight relative to the weight of the first polymer material. For example, this content may be from 70% to 75%; or from 75% to 80%; or from 80% to 85%; or from 85% to 90%; or from 90% to 95%; or from 95% to 97% by weight relative to the weight of the first polymer material.

According to one embodiment, the first polymer material consists of PEBA.

Advantageously, the PEBA copolymer has an instantaneous Shore D hardness greater than or equal to 30, preferably greater than or equal to 35 and less than or equal to 80 Shore D, preferably less than or equal to 75 Shore D.

Instantaneous hardness measurements may be performed according to the standard ISO 868: 2003.

In some embodiments, the first polymer material may comprise one or more additional polymers. This or these additional polymer(s) can be chosen from polyamides, these polyamides preferably being like those described for the types of polyamide blocks above.

According to some embodiments, the first polymer material is devoid of the hollow glass beads.

Alternatively, the first polymer material comprises hollow glass beads.

According to one embodiment, the first polymer material may comprise a hollow glass bead content of from 3% to 25%, and preferably from 4% to 20% by weight relative to the weight of the first polymer material. For example, this content may be from 3% to 5%; or from 5% to 10%; or from 10% to 15%; or from 15% to 20%; or from 20% to 25% by weight relative to the weight of the first polymer material.

A hollow glass bead is a glass material of which the structure is hollow (as opposed to solid).

The hollow glass beads may have a compressive strength, measured according to ASTM D 3102-72 (1982) in glycerol, of at least 50 MPa and particularly preferably of at least 100 MPa.

The hollow glass beads (hollow glass microspheres) typically have an aspect ratio (L/D ratio where L represents the largest dimension of the cross-section of the bead and D the smallest dimension of the cross-section of said bead) of from 0.85 to 1, in particular from 0.90 to 1, preferably equal to 1. L and D can be measured by scanning electron microscopy (SEM).

The hollow glass beads are typically spherical or substantially spherical.

Advantageously, the hollow glass beads may have a volume mean diameter D50 from 10 to 80 μm, preferably from 13 to 50 μm, measured by means of laser diffraction in accordance with the standard ASTM B 822-17.

The hollow glass beads can be surface treated with, for example, silanes (especially aminosilanes and epoxysilanes), polyamides, especially water-soluble polyamides, fatty acids, waxes, titanates, urethanes, polyhydroxyethers, epoxides, nickel or mixtures thereof. The hollow glass beads are preferably surface treated with aminosilanes, epoxysilanes, polyamides or mixtures thereof.

The hollow glass beads can be formed from a borosilicate glass, preferably from sodium carbonate-calcium oxide-borosilicate glass.

The hollow glass beads may preferably have a true density of from 0.10 to 0.80 g/cm³, preferably from 0.30 to 0.77 g/cm³, particularly preferably from 0.40 to 0.67 g/cm³, measured according to the standard ASTM D 2840-69 (1976) with a gas pycnometer and helium as the measuring gas.

According to preferred embodiments, the hollow glass beads may comprise zinc oxide having a content greater than or equal to 1.0% by weight relative to the total weight of the hollow glass beads, and preferably greater than or equal to 2.0% by weight relative to the total weight of the hollow glass beads.

The hollow glass beads suitable for the invention may be the Glass Bubbles® sold by 3M, Winlight® sold by AXYZ Chemical Co., Ltd, Sphericel® sold by Potters and SiLiBeads® sold by Sigmund-Linder.

The first polymer material may also comprise one or more additives.

The first polymer material may comprise an additive content of from 0% to 5%, and preferably from 0.1% to 4% by weight relative to the weight of the first polymer material. For example, this content can be from 0% to 0.5%; or from 0.5% to 1%; or from 1% to 1.5%; or from 1.5% to 2%; or from 2% to 2.5%; or from 2.5% to 3%; or from 3% to 3.5%; or from 3.5% to 4%; or from 4% to 4.5%; or from 4.5% to 5% by weight relative to the weight of the first polymer material.

The additive may be chosen from fillers, dyes, stabilizers, plasticizers, surface-active agents, nucleating agents, pigments, brighteners, antioxidants, lubricants, flame retardants, natural waxes, impact modifiers, additives for laser marking, and mixtures thereof.

For example, the stabilizer may be a UV stabilizer, an organic stabilizer or more generally a combination of organic stabilizers, such as a phenol-type antioxidant (for example of the Irganox® 245, 1098 or 1010 type from Ciba-BASF), a phosphite-type antioxidant (for example Irgaphos® 126 from Ciba-BASF), and possibly even other stabilizers, such as a HALS, which stands for Hindered Amine Light Stabilizer (for example Tinuvin® 770 from Ciba-BASF), a UV absorber (for example Tinuvin® 312 from Ciba) or a phosphorus-based stabilizer. Use may also be made of antioxidants of amine type, such as Naugard 445 from Crompton, or also polyfunctional stabilizers, such as Nylostab S-EED from Clariant.

This stabilizer may also be an inorganic stabilizer, such as a copper-based stabilizer. Mention may be made, as examples of such inorganic stabilizers, of copper halides and acetates. Incidentally, other metals, such as silver, can optionally be considered but these are known to be less effective. These copper-based compounds are typically combined with halides of alkali metals, in particular potassium.

By way of example, the plasticizers are chosen from benzenesulfonamide derivatives, such as n-butylbenzenesulfonamide (BBSA); ethyltoluenesulfonamide or N-cyclohexyltoluenesulfonamide; esters of hydroxybenzoic acids, such as 2-ethylhexyl para-hydroxybenzoate and 2-decylhexyl para-hydroxybenzoate; esters or ethers of tetrahydrofurfuryl alcohol, such as oligoethyleneoxytetrahydrofurfuryl alcohol; and esters of citric acid or of hydroxymalonic acid, such as oligoethyleneoxy malonate.

By way of example, the fillers can be chosen from silica, graphite, expanded graphite, carbon black, kaolin, magnesia, slag, talc, wollastonite, mica, nanofillers (carbon nanotubes), pigments, metal oxides (titanium oxide), metals, advantageously wollastonite and talc, preferentially talc.

By way of example, the impact modifiers are polyolefins having a modulus <200 MPa, in particular <100 MPa, as measured according to the standard ISO 178:2010, at 23° C.

In one embodiment, the impact modifier is chosen from a functionalized or non-functionalized polyolefin having a modulus <200 MPa, in particular <100 MPa, and mixtures thereof.

Advantageously, the functionalized polyolefin bears a function chosen from maleic anhydride, carboxylic acid, carboxylic anhydride and epoxide functions, and is chosen in particular from ethylene/octene copolymers, ethylene/butene copolymers, ethylene/propylene elastomers (EPR), ethylene/propylene/diene copolymers of elastomeric nature (EPDM) and ethylene/alkyl (meth)acrylate copolymers.

By way of example, the additives for laser marking are: Iriotec® 8835/Iriotec® 8850 from Merck and Laser Mark® 1001074-E/Laser Mark® 1001088-E from Ampacet Corporation.

The first polymer material may be in the form of a layer in the article according to the invention.

### Second Polymer Material

The second polymer material according to the invention comprises at least one thermoplastic polyurethane (TPU). The thermoplastic polyurethane may be chosen from a copolyether block urethane and a copolyester block urethane.

The thermoplastic polyurethane (TPU) according to the invention is a copolymer with rigid blocks and flexible blocks. The TPUs result from the reaction of at least one polyisocyanate with at least one isocyanate-reactive compound, preferably having two isocyanate-reactive functional groups, more preferentially a polyol, and optionally with a chain extender, optionally in the presence of a catalyst.

The rigid TPU blocks are blocks consisting of units derived from polyisocyanates and chain extenders, while the flexible blocks predominantly comprise units derived from isocyanate-reactive compounds having a molar mass of between 0.5 and 100 kg/mol, preferably polyols.

The polyisocyanate may be aliphatic, cycloaliphatic, araliphatic and/or aromatic. Preferably, the polyisocyanate is a diisocyanate. Advantageously, the polyisocyanate is chosen from the group consisting of tri-, tetra-, penta-, hexa-, hepta- and/or octamethylene diisocyanate, 2-methylpentamethylene-1,5-diisocyanate, 2-ethylbutylene-1,4-diisocyanate, 1,5-pentamethylene diisocyanate, 1,4-butylene diisocyanate, 1-isocyanato-3,3,5-trimethyl-5-isocyanatomethylcyclohexane (isophorone diisocyanate, IPDI), 1,4-bis(isocyanatomethyl)cyclohexane, 1,3-bis(isocyanatomethyl)cyclohexane (HXDI), 2,4-paraphenylene diisocyanate (PPDI), 2,4-tetramethylenexylene diisocyanate (TMXDI), 4,4′-, 2,4′- and/or 2,2′-dicyclohexylmethane diisocyanate (H12 MDI), 1,4-cyclohexane diisocyanate, 1-methyl-2,4- and/or 1-methyl-2,6-cyclohexane diisocyanate, 2,2′-, 2,4′- and/or 4,4′-diphenylmethane diisocyanate (MDI), 1,5-naphthylene diisocyanate (NDI), 2,4- and/or 2,6-toluene diisocyanate (TDI), diphenylmethane diisocyanate, 3,3′-dimethyldiphenyl diisocyanate, 1,2-diphenylethane diisocyanate, phenylene diisocyanate, methylenebis(4-cyclohexylisocyanate) (HMDI) and mixtures thereof.

More preferably, the polyisocyanate is chosen from the group consisting of diphenylmethane diisocyanates (MDI), toluene diisocyanates (TDI), pentamethylene diisocyanate (PDI), hexamethylene diisocyanate (HDI), methylenebis(4-cyclohexyl isocyanate) (HMDI) and mixtures thereof.

Even more preferably, the polyisocyanate is 4,4′-MDI (diphenylmethane-4,4′-diisocyanate), 1,6-HDI (hexamethylene-1,6-diisocyanate) or a mixture thereof.

The isocyanate-reactive compound(s) preferably have an average functionality of between 1.8 and 3, more preferably between 1.8 and 2.6, more preferably between 1.8 and 2.2. The average functionality of the isocyanate-reactive compound(s) corresponds to the number of isocyanate-reactive functions of the molecules, calculated theoretically for one molecule from a quantity of compounds. Preferably, the isocyanate-reactive compound has, according to a statistical mean, a Zerewitinoff active hydrogen number within the above ranges.

Preferably, the isocyanate-reactive compound (preferably a polyol) has a number-average molar mass of from 500 to 100,000 g/mol. The isocyanate-reactive compound may have a number-average molar mass of from 500 to 8000 g/mol, more preferably from 700 to 6000 g/mol, more particularly from 800 to 4000 g/mol. In embodiments, the isocyanate-reactive compound has a number-average molar mass of from 500 to 600 g/mol, or from 600 to 700 g/mol, or from 700 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 10,000 g/mol, or from 10,000 to 15,000 g/mol, or from 15,000 to 20,000 g/mol, or from 20,000 to 30,000 g/mol, or from 30,000 to 40,000 g/mol, or from 40,000 to 50,000 g/mol, or from 50,000 to 60,000 g/mol, or from 60,000 to 70,000 g/mol, or from 70,000 to 80,000 g/mol, or from 80,000 to 100,000 g/mol. The number-average molar mass may be determined by GPC, preferably according to the standard ISO 16014-1:2012.

Advantageously, the isocyanate-reactive compound has at least one reactive group chosen from a hydroxyl group, amine group, thiol group and carboxylic acid group. Preferably, the isocyanate-reactive compound has at least one reactive hydroxyl group, more preferentially several hydroxyl groups. Thus, particularly advantageously, the isocyanate-reactive compound comprises or consists of a polyol.

Preferably, the polyol is chosen from the group consisting of polyester polyols, polyether polyols, polycarbonate diols, polysiloxane diols, polyalkylene diols and mixtures thereof. More preferably, the polyol is a polyether polyol, polyester polyol and/or polycarbonate diol, so that the flexible blocks of the thermoplastic polyurethane are polyether blocks, polyester blocks and/or polycarbonate blocks, respectively. Preferably also, the flexible blocks of the thermoplastic polyurethane are polyether blocks and/or polyester blocks (the polyol being a polyether polyol and/or a polyester polyol).

As polyester polyol, mention may be made of polycaprolactone polyols and/or copolyesters based on one or more carboxylic acids chosen from adipic acid, succinic acid, pentanedioic acid and/or sebacic acid and on one or more alcohols chosen from 1,2-ethanediol, 1,3-propanediol, 1,4-butanediol, 1,5-pentanediol, 3-methyl-1,5-pentanediol, 1,6-hexanediol and/or polytetrahydrofuran. More particularly, the copolyester may be based on adipic acid and a mixture of 1,2-ethanediol and 1,4-butanediol, or the copolyester may be based on adipic acid, succinic acid, pentanedioic acid, sebacic acid or mixtures thereof, and polytetrahydrofuran (tetramethylene glycol), or the copolyester may be a mixture of these copolyesters.

Polyetherdiols (i.e. aliphatic α,ω-dihydroxyl polyoxyalkylene blocks) are preferably used as polyether polyol. Preferably, the polyether polyol is a polyetherdiol based on ethylene oxide, propylene oxide, and/or butylene oxide, a block copolymer based on ethylene oxide and propylene oxide, a polyethylene glycol, a polypropylene glycol, a polybutylene glycol, a polytetrahydrofuran, a polybutanediol or a mixture thereof. The polyether polyol is preferably a polytetrahydrofuran (flexible blocks of the thermoplastic polyurethane therefore being polytetrahydrofuran blocks) and/or a polypropylene glycol (flexible blocks of the thermoplastic polyurethane therefore being polypropylene glycol blocks) and/or a polyethylene glycol (flexible blocks of the thermoplastic polyurethane therefore being polyethylene glycol blocks), preferably a polytetrahydrofuran having a number-average molar mass of from 500 to 15,000 g/mol, preferably from 1000 to 3000 g/mol. The polyether polyol may be a polyetherdiol which is the reaction product of ethylene oxide and propylene oxide; the molar ratio of the ethylene oxide relative to the propylene oxide is preferably from 0.01 to 100, more preferentially from 0.1 to 9, more preferentially from 0.25 to 4, more preferentially from 0.4 to 2.5, more preferentially from 0.6 to 1.5 and it is more preferentially 1.

The polysiloxane diols which can be used in the invention preferably have a number-average molar mass of from 500 to 15,000 g/mol, preferably of from 1000 to 3000 g/mol. The number-average molar mass may be determined by GPC, preferably according to the standard ISO 16014-1:2012. Advantageously, the polysiloxane diol is a polysiloxane of formula (I):

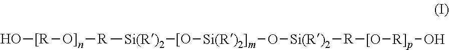

wherein R is preferably a C₂-C₄ alkylene, R′ is preferably a C₁-C₄ alkyl and each of n, m and p independently represents an integer preferably between 0 and 50, m more preferably being from 1 to 50, even more preferentially from 2 to 50. Preferably, the polysiloxane has the formula (II) below:

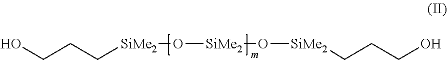

wherein Me is a methyl group,
or the formula (III) below:

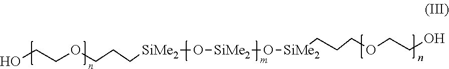

The polyalkylene diols which can be used in the invention are preferably based on butadiene.

The polycarbonate diols which can be used in the invention are preferably aliphatic polycarbonate diols. The polycarbonate diol is preferably based on alkanediol. Preferably, it is strictly difunctional. The preferred polycarbonate diols according to the invention are those based on butanediol, pentanediol and/or hexanediol, in particular 1,4-butanediol, 1,5-pentanediol, 1,6-hexanediol, 3-methylpentane-(1,5)-diol, or mixtures thereof, more preferentially based on 1,4-butanediol, 1,5-pentanediol, 1,6-hexanediol, or mixtures thereof. In particular, the polycarbonate diol may be a polycarbonate diol based on butanediol and hexanediol, or based on pentanediol and hexanediol, or based on hexanediol, or may be a mixture of two or more of these polycarbonate diols. The polycarbonate diol advantageously has a number-average molar mass ranging from 500 to 4000 g/mol, preferably from 650 to 3500 g/mol, more preferentially from 800 to 3000 g/mol. The number-average molar mass may be determined by GPC, preferably according to the standard ISO 16014-1:2012.

One or more polyols may be used as isocyanate-reactive compound.

In a particularly preferred manner, the flexible blocks of the TPU are polytetrahydrofuran, polypropylene glycol and/or polyethylene glycol blocks.

Preferably, a chain extender is used for the preparation of the thermoplastic polyurethane, in addition to the isocyanate and the isocyanate-reactive compound.

The chain extender may be aliphatic, araliphatic, aromatic and/or cycloaliphatic. Advantageously, it has a number-average molar mass of from 50 to 499 g/mol. The number-average molar mass may be determined by GPC, preferably according to the standard ISO 16014-1:2012. The chain extender preferably has two isocyanate-reactive groups (also referred to as “functional groups”). It is possible to use a single chain extender or a mixture of at least two chain extenders.

The chain extender is preferably bifunctional. Examples of chain extenders are diamines and alkanediols having from 2 to 10 carbon atoms. In particular, the chain extender may be chosen from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanol cyclohexane, neopentyl glycol, hydroquinone bis(beta-hydroxyethyl) ether (HQEE), di-, tri-, tetra-, penta-, hexa-, hepta-, octa-, nona- and/or deca-alkylene glycol, their respective oligomers, polypropylene glycol and mixtures thereof. More preferentially, the chain extender is chosen from the group consisting of 1,2-ethylene glycol, 1,3-propanediol, 1,4-butanediol, 1,5-pentanediol, 1,6-hexanediol, and mixtures thereof, and more preferably it is chosen from 1,3-propanediol, 1,4-butanediol and/or 1,6-hexanediol. Even more preferentially, the chain extender is a mixture of 1,4-butanediol and 1,6-hexanediol, more preferentially in a molar ratio of 6:1 to 10:1.

Advantageously, a catalyst is used to synthesize the thermoplastic polyurethane. The catalyst makes it possible to accelerate the reaction between the NCO groups of the polyisocyanate and the isocyanate-reactive compound (preferably the hydroxyl groups of the isocyanate-reactive compound) and, if present, with the chain extender.

The catalyst is preferably a tertiary amine, more preferentially chosen from triethylamine, dimethylcyclohexylamine, N-methylmorpholine, N,N′-dimethylpiperazine, 2-(dimethylaminoethoxy) ethanol and/or diazabicyclo-(2,2,2)-octane. Alternatively, or additionally, the catalyst is an organic metal compound such as a titanium acid ester, an iron compound, preferably ferric acetylacetonate, a tin compound, preferably those of carboxylic acids, more preferentially tin diacetate, tin dioctoate, tin dilaurate or dialkyl tin salts, preferably dibutyltin diacetate and/or dibutyltin dilaurate, a bismuth carboxylic acid salt, preferably bismuth decanoate, or a mixture thereof.

More preferably, the catalyst is chosen from the group consisting of tin dioctoate, bismuth decanoate, titanium acid esters and mixtures thereof. More preferably, the catalyst is tin dioctoate.

During the preparation of the thermoplastic polyurethane, the molar ratios of the isocyanate-reactive compound and the chain extender can be varied to adjust the hardness and melt flow index of the TPU. Specifically, when the proportion of chain extender increases, the hardness and the melt viscosity of the TPU increases while the melt flow index of the TPU decreases. For the production of flexible TPU, preferably TPU having a Shore A hardness of less than 95, more preferentially from 75 to 95, the isocyanate-reactive compound and the chain extender can be used in a molar ratio of from 1:1 to 1:5, preferably from 1:1.5 to 1:4.5, preferably so that the mixture of isocyanate-reactive compound and chain extender has a hydroxyl equivalent weight of greater than 200, more particularly from 230 to 650, even more preferentially from 230 to 500. For the production of a harder TPU, preferably a TPU having a Shore A hardness of greater than 98, preferably a Shore D hardness of 55 to 75, the isocyanate-reactive compound and the chain extender can be used in a molar ratio of 1:5.5 to 1:15, preferably from 1:6 to 1:12, preferably so that the mixture of isocyanate-reactive compound and chain extender has a hydroxyl equivalent weight of from 110 to 200, more preferentially from 120 to 180.

Advantageously, in order to prepare the TPU, the polyisocyanate, the isocyanate-reactive compound and preferably the chain extender are reacted, preferably in the presence of a catalyst, in amounts such that the equivalent ratio of the NCO groups of the polyisocyanate to the sum of the hydroxyl groups of the isocyanate-reactive compound and the chain extender is from 0.95:1 to 1.10:1, preferably from 0.98:1 to 1.08:1, more preferably from 1:1 to 1.05:1. The catalyst is advantageously present in an amount of 0.0001 to 0.1 parts by weight per 100 parts by weight of the TPU synthesis reagents.

The TPU according to the invention preferably has a weight-average molar mass of greater than or equal to 10,000 g/mol, preferably greater than or equal to 40,000 g/mol and more preferentially greater than or equal to 60,000 g/mol. Preferably, the weight-average molar mass of the TPU is less than or equal to 80,000 g/mol. The weight-average molar masses can be determined by gel permeation chromatography (GPC).

Advantageously, the TPU is semicrystalline. Its melting temperature Tm is preferably between 100° C. and 230° C., more preferably between 120° C. and 200° C. The melting temperature can be measured according to the standard ISO 11357-3 Plastics-Differential scanning calorimetry (DSC) Part 3.

Advantageously, the TPU may be a recycled TPU and/or a partially or totally biobased TPU.

Preferably, the TPU has a Shore D hardness of less than or equal to 75 D, more preferentially less than or equal to 65 D. In particular, the TPU used in the invention may have a hardness of 65 Shore A to 70 Shore D, preferably of 75 Shore A to 60 Shore D. The hardness measurements may be carried out according to the standard ISO 7619-1.

The second polymer material may comprise a single TPU (as described above) or several of these TPUs as a mixture.

The second polymer material may comprise a TPU content of from 70% to 97%, and preferably from 80% to 96% by weight relative to the weight of the second polymer material. For example, this content may be from 70% to 75%; or from 75% to 80%; or from 80% to 85%; or from 85% to 90%; or from 90% to 95%; or from 95% to 97% by weight relative to the weight of the second polymer material.

According to some embodiments, the second polymer material may also comprise at least one thermoplastic elastomer (TPE) polymer which is different from the thermoplastic polyurethane (TPU). This TPE may be chosen from a PEBA (as described above), a copolyether block ester (CoPE) and combinations thereof.

The CoPE comprises at least one polyether (PE) block, and at least one polyester PES (homopolymer or copolyester) block.

The polyester block can be obtained by polycondensation by esterification of a carboxylic acid, such as isophthalic acid or terephthalic acid or a biobased carboxylic acid (such as furan dicarboxylic acid), with a glycol, such as ethylene glycol, trimethylene glycol, propylene glycol or tetramethylene glycol. The polyether blocks may be as described above in the description of the PEBAs.

The second polymer material comprises hollow glass beads.

The hollow glass beads may thus be present either only in the second polymer material or in the first and the second polymer material.

The hollow glass beads are as described above.

The second polymer material may comprise a hollow glass bead content of from 3% to 25%, and preferably from 4% to 20% by weight relative to the weight of the second polymer material. For example, this content may be from 3% to 5%; or from 5% to 10%; or from 10% to 15%; or from 15% to 20%; or from 20% to 25% by weight relative to the weight of the second polymer material.

According to preferred embodiments, the hollow glass beads may comprise zinc oxide having a content greater than or equal to 1.0% by weight relative to the total weight of the hollow glass beads, and preferably greater than or equal to 2.0% by weight relative to the total weight of the hollow glass beads.

The second polymer material may also comprise one or more additives. These additives are as described above in connection with the first material.

The second polymer material may comprise an additive content of from 0% to 5%, and preferably from 0.1% to 4% by weight relative to the weight of the second polymer material. For example, this content can be from 0% to 0.5%; or from 0.5% to 1%; or from 1% to 1.5%; or from 1.5% to 2%; or from 2% to 2.5%; or from 2.5% to 3%; or from 3% to 3.5%; or from 3.5% to 4%; or from 4% to 4.5%; or from 4.5% to 5% by weight relative to the weight of the second polymer material.

The second polymer material may be in the form of a layer in the article according to the invention.

The article according to the invention may also comprise one or more layers of additional materials.

According to one embodiment, the article of the invention comprises:
60-95% by weight of the first polymer material and the second polymer material;
3-25% by weight of the hollow glass beads;
0-10% by weight of one or more additives;
the total amounting to 100% by weight of the article.

### Adhesion Process

The present invention also relates to a process for the direct adhesion of a first polymer material as described above to a second polymer material as described above.

According to one embodiment, the first polymer material is melted or softened under heating, and this molten material is brought into contact with at least a portion of the second polymer material so as to adhere the two materials together.

According to another embodiment, the first polymer material and the second polymer material are independently melted or softened under heating, and the molten first polymer material is brought into contact with at least a portion of the molten second polymer material so as to adhere the two materials together.

Advantageously, in the assembly process according to the invention, the first polymer material and the second polymer material are assembled by a direct adhesion process chosen from: overmolding, hot pressing, coextrusion, thermoforming, injection molding, extrusion molding, blow molding, and mixtures thereof; preferably by overmolding.

According to one embodiment, the process is a process of overmolding the first polymer material, containing or not containing hollow glass beads, onto the second polymer material containing hollow glass beads.

According to one embodiment, the hollow glass beads comprise zinc oxide having a content greater than or equal to 1.0% by weight relative to the total weight of the hollow glass beads, and preferably greater than or equal to 2.0% by weight relative to the total weight of the hollow glass beads.

Advantageously, the assembly temperature of the direct adhesion process according to the invention is from 220 to 300° C., preferably from 240 to 290° C., preferably from 250 to 290° C.

Such a process can, for example, be carried out by joining the first and second polymer materials in an injection molding process, in particular two-material injection, two-color injection, multicolor injection, two-injection or co-injection molding process. Other conventional processes may be used: thermoforming, hot press molding, insert molding, sandwich injection molding, extrusion molding, in particular coextrusion molding, injection blow molding, and other processes for processing TPE materials. A person skilled in the art chooses the type of injection molding machine according to the type of mold, insert and materials to be injected.

According to one particular embodiment of hot press molding, the first and second polymer materials in the form of granules, powder or any other form are loaded into a metal mold.

According to another embodiment, the first and second polymer materials, in the form of premolded articles, are loaded into a metal mold.

According to yet another embodiment of insert injection molding, a molded composite article may be produced by: molding the second polymer material using a process such as injection molding, extrusion molding, notably sheet molding, or film molding; then insertion or forming of the thus molded article in a metal mold; then injection of the first polymer material not yet molded into a space or cavity between the molded article and the metal mold. In insert injection molding, the molded article to be inserted into the metal mold is preferably preheated in the metal mold.

### EXAMPLES

The following examples illustrate the invention without limiting it.

### Materials Used:

PEBA 1: a copolymer comprising PA11 blocks and PTMG blocks with an instantaneous hardness of 53 Shore D.
TPU 1: commercial product Elastollan® 1195A (BASF)—a copolyether block urethane, 95 Shore A.
TPU 2: commercial product Pearlthane® ECO 12T95 (Lubrizol)—a copolyester block urethane, 95 Shore A.
R1: hollow glass beads, density 0.60 g/cc, D50=30 μm, the ZnO content is about 3%, the compressive strength is 125 MPa.

In the context of the present invention, the adhesion between two polymer materials is expressed by the peel strength in kgf/cm, measured according to the standard ISO11339.

### Example 1

Various second polymer materials (SPMs) were prepared as illustrated in table 1. The SPM compositions from table 1 were prepared by melt mixing the TPU granules with the hollow glass beads and the stabilizing additives (antioxidants). This mixing was carried out by compounding on a corotating twin-screw extruder having a diameter of 26 mm with a flat temperature (T°) profile at 185° C. The screw speed is 250 rpm and the throughput is 15 kg/h. The TPU(s) and the additives are introduced into the main hopper. The hollow glass beads are introduced by side feeding.

The compositions were then molded on an injection molding machine (Toshiba), at a set temperature of 220° C. and a mold temperature of 20° C., in the form of 2 mm thick plates. The insert plates thus prepared were then placed in a mold 4 mm thick for overmolding.

TABLE 1

| | SPM1 | SPM2 | SPM3 | SPM4 | SPM5 | SPM6 |
|---|---|---|---|---|---|---|
| TPU 1 (%) | 100 | 89.7 | 79.7 | — | — | — |
| TPU 2 (%) | — | — | — | 100 | 89.7 | 79.7 |
| stabilizer (%) | — | 0.3 | 0.3 | — | 0.3 | 0.3 |
| R1 (%) | — | 10 | 20 | — | 10 | 20 |

PEBA1 was then overmolded onto the inserts of the various SPMs 1 to 6 at an assembly temperature of 260° C. and a mold temperature of 60° C.

The overmolded articles thus prepared were then cut into strips 20 mm wide, on which peel tests were carried out according to the standard ISO11339 with a separation speed of 100 mm/min. The results of these tests are given in table 2 below.

The following table compares the adhesion (peel strength in kgf/cm) of PEBA 1 (first polymer material) to the SPM 1 to 6 inserts (second polymer materials), after direct adhesion by overmolding.

TABLE 2

| | SPM1 | SPM2 | SPM3 | SPM4 | SPM5 | SPM6 |
|---|---|---|---|---|---|---|
| PEBA 1 | 19 | 23 | ≥20 | 19 | 21 | ≥21 |

It is found that the first polymer material PEBA 1 has an adhesion to the second polymer materials (SPM2, SPM3, SPM5 and SPM6) which is similar, or even improved, compared to the second polymer materials devoid of the hollow glass beads (SPM1 and SPM4).

The density of the overmolded articles was measured according to the standard ISO 1183-3:1999 (Table 3).

TABLE 3

| | SPM1 | SPM2 | SPM3 | SPM4 | SPM5 | SPM6 |
|---|---|---|---|---|---|---|
| PEBA 1 | 1.08 | 1.05 | 1.02 | 1.10 | 1.06 | 1.03 |

It is found that the density of the overmolded articles comprising hollow glass beads is reduced compared to the overmolded articles not comprising hollow glass beads (SPM1-PEBA1 and SPM4-PEBA1).

### Example 2

In this example, peel tests were carried out using the second polymer materials SPM1 and SPM3 (as described in example 1) as inserts, onto which the first polymer materials FPM1, FPM2 or FPM3 are overmolded. Compositions FPM1 to FPM3 from table 4 were prepared by melt mixing the PEBA granules with the hollow glass beads and the stabilizing additives (antioxidants). This mixing was carried out by compounding on a corotating twin-screw extruder having a diameter of 26 mm with a flat temperature (T°) profile at 250° C. The screw speed is 250 rpm and the throughput is 20 kg/h. The PEBA(s) and the additives are introduced into the main hopper. The hollow glass beads are introduced by side feeding.

The compositions were then overmolded at a set temperature of 260° C. and a mold temperature of 60° C. in the form of 2 mm thick plates onto the inserts of the various materials SPM1 and SPM3.

The overmolded articles thus prepared were then cut into strips 20 mm wide, on which peel tests were carried out according to the standard ISO11339 with a separation speed of 100 mm/min.

TABLE 4

| | FPM1 | FPM2 | FPM3 |
|---|---|---|---|
| PEBA 1 (%) | 100 | 89.7 | 79.7 |
| stabilizer (%) | — | 0.3 | 0.3 |
| R1 (%) | — | 10 | 20 |

The following table 5 compares the adhesion (peel strength in kgf/cm) of FPM1 and FPM3 to the SPM1 and 3 inserts, after direct adhesion by overmolding.

TABLE 5

| | FPM1 | FPM2 | FPM3 |
|---|---|---|---|
| SPM1 | 19 | ≥22 | ≥21 |
| SPM3 | ≥18 | ≥18 | ≥18 |

The density of the overmolded articles was measured according to the standard ISO 1183-3:1999 (Table 6).

TABLE 6

| | FPM1 | FPM2 | FPM3 |
|---|---|---|---|
| SPM1 | 1.08 | 1.06 | 1.04 |
| SPM3 | 1.01 | 0.98 | 0.96 |

It is found that the density of the overmolded articles comprising hollow glass beads is reduced compared to the overmolded articles not comprising hollow glass beads (SPM1-FPM1).

It is found that, even in the case where the hollow glass beads are present in the first and the second polymer material, the invention makes it possible to obtain articles of lower density and with an adhesion between the materials which is similar, or even improved, compared to the (first or second) polymer materials devoid of the hollow glass beads.

### Example 3 (Counter-Example)

In this example, a peel test was carried out using the first polymer material FPM1 as described in example 2 as insert, onto which the second polymer material SPM3 as described in example 1 is overmolded. The composition was then overmolded, at a set temperature of 230° C. and a mold temperature of 60° C., in the form of 2 mm thick plates, onto the FPM1 insert.

The overmolded article thus prepared was then cut into strips 20 mm wide, on which peel tests were carried out according to the standard ISO11339 with a separation speed of 100 mm/min.

The adhesion (peel strength in kgf/cm) of SPM3 overmolded onto the FPM1 insert was measured at 4 kgf/cm, which is markedly lower than the peel strength measured on the adhesion of FPM1 overmolded onto the SPM3 insert (>20, table 2).

1. An article comprising a first polymer material comprising at least one copolymer comprising polyamide blocks and polyether blocks (PEBA) and a second polymer material comprising at least one thermoplastic polyurethane (TPU), the first polymer material adhering directly to the second polymer material, and the second polymer material comprising hollow glass beads.

2. The article as claimed in claim 1, wherein the adhesion between two polymer materials, expressed as the peel strength in kgf/cm, is greater than or equal to 10 kgf/cm.

3. The article as claimed in claim 1, wherein the PEBA copolymer has an instantaneous Shore D hardness greater than or equal to 30.

4. The article as claimed in claim 1, wherein the PA blocks of the PEBA copolymer are chosen from PA 6, 11, 12, 612, 66/6, 1010, 614, and/or the copolymer thereof; and/or the PE blocks of the PEBA copolymer are PTMG blocks.

5. The article as claimed in claim 1, wherein the hollow glass beads have a content of 3% to 25% by weight relative to the total weight of the second polymer material.

6. The article as claimed in claim 1, wherein the first polymer material comprises a hollow glass bead content of 3% to 25% by weight relative to the weight of the first polymer material.

7. The article as claimed in claim 1, wherein the hollow glass beads comprise zinc oxide having a content greater than or equal to 1.0% by weight relative to the total weight of the hollow glass beads.

8. The article as claimed in claim 1, comprising:
60-95% by weight of the first polymer material and the second polymer material;
3-25% by weight of the hollow glass beads; and
0-10% of one or more additives;
the total amounting to 100% by weight of the article.

9. A method comprising using an article as claimed in claim 1, for the manufacture of sports equipment, a shoe element, personal protective equipment, automotive parts, construction parts, optical equipment parts, electrical and electronic equipment parts, medical equipment parts such as catheters, or transmission or conveyor belts.

10. A process for direct adhesion of a first polymer material comprising at least one copolymer comprising polyamide blocks and polyether blocks to a second polymer material comprising at least one thermoplastic polyurethane and hollow glass beads, wherein the assembly is carried out by a process comprising heating the first polymer material, and this material melted or softened under heating is brought into contact with at least a portion of the second polymer material so as to adhere the two materials together.

11. The process as claimed in claim 10, wherein the first polymer material and the second polymer material are assembled by a direct adhesion process chosen from: overmolding, hot pressing, coextrusion, thermoforming, injection molding, extrusion molding, blow molding, and mixtures thereof.

12. The process as claimed in claim 10, being a process of overmolding the first polymer material onto the second polymer material containing hollow glass beads.

13. The process as claimed in claim 10, wherein the hollow glass beads comprise zinc oxide having a content greater than or equal to 1.0% by weight relative to the total weight of the hollow glass beads.

14. The process as claimed in claim 10, wherein the assembly temperature is within the range from 220 to 300° C.
